(19) United States
(12) Patent Application Publication
(10) Pub. No.: US 2025/0162880 A1
(43) Pub. Date: May 22, 2025

(54) CARBIDE PRODUCTION SYSTEM AND CARBIDE PRODUCTION METHOD

(71) Applicant: IHI CORPORATION, Tokyo (JP)

(72) Inventor: Michinori NARISAWA, Tokyo (JP)

(73) Assignee: IHI CORPORATION, Tokyo (JP)

(21) Appl. No.: 18/957,059

(22) Filed: Nov. 22, 2024

Related U.S. Application Data
(63) Continuation of application No. PCT/JP2023/015778, filed on Apr. 20, 2023.

(30) Foreign Application Priority Data
Jun. 27, 2022 (JP) 2022-102517

(51) Int. Cl. C01B 32/90

(52) U.S. Cl. CPC C01B 32/90

(57) ABSTRACT

A carbide production system includes a combustion furnace having a first biomass supply port for supplying first biomass and including a combustion chamber for burning the first biomass with air; and a carbide recovery device connected to the combustion furnace for recovering carbides produced from the second biomass. The second biomass is supplied through a second biomass supply port provided downstream of the first biomass supply port to a carbonization region in which a low-concentration oxygen gas produced by heating due to combustion of the first biomass and having an oxygen concentration lower than air due to the combustion of the first biomass exists.

### CROSS REFERENCE TO RELATED APPLICATIONS

This application is a continuation application of International Application No. PCT/JP2023/015778, filed on Apr. 20, 2023, which claims priority to Japanese Patent Application No. 2022-102517, filed on Jun. 27, 2022, the entire contents of which are incorporated by reference herein.

### BACKGROUND

### 1. Technical Field

The present disclosure relates to a carbide production system and a carbide production method.

### 2. Description of the Related Art

Conventionally, a method for producing carbides by heating biomass has been known. By producing carbides from biomass, carbon in the biomass is fixed as carbides, and emissions of carbon dioxide into the atmosphere can be prevented compared with a case of burning biomass.

JP 6285588 discloses a self-combustion carbonization heat treatment device including a cylindrical main body, a lid for closing an upper opening of the main body, a partition wall plate with ventilation holes arranged at a position separated from a bottom plate, and an air supply passage for introducing air into an air supply chamber formed between the bottom plate and the partition wall plate. JP 6285588 discloses the self-combustion carbonization heat treatment device including a plurality of air supply cylindrical bodies having ventilation holes and erected on the partition wall plate in communication with the ventilation holes of the partition wall plate.

### SUMMARY

The self-combustion carbonization heat treatment device described above generates carbides in a batch system, and cooling time and raw material charging time are required separately for taking out carbides. Therefore, continuous processing is not possible, and productivity is low. Further, in the self-combustion carbonization heat treatment device, the raw material spontaneously burns in a state lacking oxygen, and the raw material is carbonized in the same region as the combustion region. Therefore, there is a possibility that the conditions for producing carbides are not stable. In this case, the biomass burns more than necessary, and there is a possibility that the properties of the carbides are not stable, for example, the amount of carbides obtained is reduced.

Therefore, it is an object of the present disclosure to provide a carbide production system and a carbide production method capable of continuously producing stable carbides from biomass.

A carbide production system according to the present disclosure includes a combustion furnace having a first biomass supply port for supplying first biomass and including a combustion chamber for burning the first biomass with air; and a carbide recovery device connected to the combustion furnace for recovering carbides produced from second biomass. The second biomass is supplied through a second biomass supply port provided downstream of the first biomass supply port to a carbonization region in which a low-concentration oxygen gas produced by heating due to combustion of the first biomass and having an oxygen concentration lower than air due to the combustion of the first biomass exists.

The combustion furnace may be a vertical combustion furnace.

The combustion chamber may be provided with a second biomass supply port for supplying the second biomass into the combustion chamber. Carbides may be produced in the combustion chamber.

The combustion furnace and the carbide recovery device may be connected through a connecting channel. The connecting channel may be provided with the second biomass supply port for supplying the second biomass into the connecting channel. The carbides may be produced in the connecting channel.

The combustion furnace and the carbide recovery device may be connected through a connecting channel. The connecting channel may be provided with an air supply port for supplying air into the connecting channel.

The carbide recovery device may include a cyclone.

The carbide production system may further include a gas utilization device for utilizing a gas exhausted from the carbide recovery device. The carbides may be cooled in the carbide recovery device by a gas derived from a gas exhausted from the carbide recovery device and cooled by heat exchange in the gas utilization device.

A carbide production method according to the present disclosure includes burning first biomass supplied to a combustion chamber of a combustion furnace with air. The carbide production method includes supplying second biomass to a carbonization region downstream of the first biomass, in which a low-concentration oxygen gas produced by heating due to combustion of the first biomass and having an oxygen concentration lower than air due to combustion of the first biomass exists. The carbide production method includes recovering carbides produced from the second biomass in a carbide recovery device connected to the combustion furnace.

According to the present disclosure, a carbide production system and a carbide production method capable of continuously producing stable carbides from biomass can be provided.

### BRIEF DESCRIPTION OF THE DRAWINGS

FIG. 1 is a schematic view illustrating a carbide production system according to an embodiment.

FIG. 2 is a schematic view illustrating a state in the vicinity of a second biomass supply port.

FIG. 3 is a cross-sectional view of FIG. 2 taken along line III-III.

FIG. 4 is a schematic view illustrating a state in the vicinity of a second biomass supply port according to another embodiment.

FIG. 5 is a cross-sectional view taken along line V-V in FIG. 4.

FIG. 6 is a schematic view illustrating a state in the vicinity of a second biomass supply port according to another embodiment.

FIG. 7 is a cross-sectional view taken along line VII-VII in FIG. 6.

FIG. 8 is a schematic view illustrating a carbide production system according to an embodiment.

FIG. 9 is a schematic view illustrating a carbide production system according to an embodiment.

### DESCRIPTION OF THE EMBODIMENTS

Several exemplary embodiments will now be described with reference to the drawings. The dimensional ratios in the drawings are exaggerated for the sake of explanation and may differ from the actual ratios.

### First Embodiment

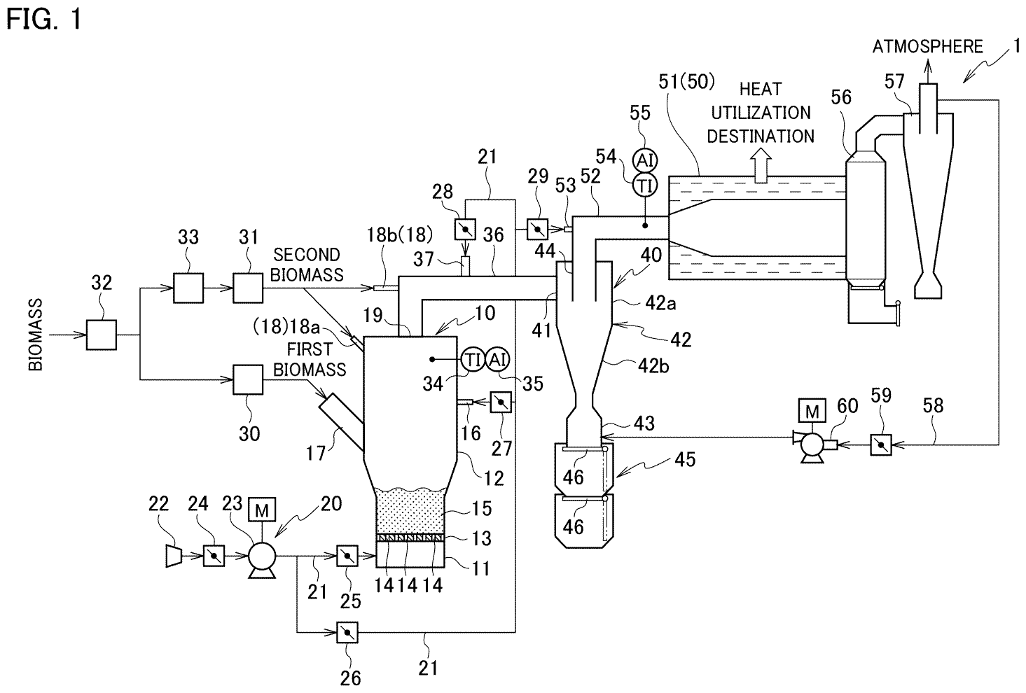

First, a carbide production system 1 according to a first embodiment will be described with reference to FIGS. 1 to 7. As illustrated in FIG. 1, the carbide production system 1 according to the present embodiment includes a combustion furnace 10 and a carbide recovery device 40. The combustion furnace 10 is configured to burn first biomass. The carbide recovery device 40 recovers carbides. As will be described later, carbides are produced from second biomass.

The combustion furnace 10 is a vertical fluidized bed combustion furnace in the present embodiment. The vertical combustion furnace is superior in that it does not require a large installation area. However, the combustion furnace 10 is not limited to a vertical combustion furnace, and may be a horizontal combustion furnace. The combustion furnace 10 is not limited to a fluidized bed combustion furnace, and may be a rotary combustion furnace such as a grate combustion furnace or a kiln combustion furnace.

The combustion furnace 10 includes a wind box 11 and a combustion chamber 12 provided vertically above the wind box 11. The wind box 11 is a room for supplying combustion air. The combustion chamber 12 is a chamber for burning the first biomass with air. The wind box 11 and the combustion chamber 12 are partitioned by an air dispersion plate 13. The air dispersion plate 13 has a plurality of first air supply holes 14.

The plurality of first air supply holes 14 are first air supply ports for supplying air to the combustion chamber 12. The air supplied through the first air supply holes 14 is primary air. The primary air is supplied to the fluidizing medium 15 and is mainly used for combustion. The air supplied from the air supply section 20 is supplied to the combustion chamber 12 through the wind box 11 and the plurality of first air supply holes 14. In the present embodiment, the air diffusion system of the combustion furnace 10 is a dispersing plate type, but it may be a diffusing pipe type or a combination thereof.

The air supply section 20 is connected to the wind box 11. The air supply section 20 includes an airflow channel 21, an air intake port 22, and a blower 23. The airflow channel 21 is provided with an air intake port 22 and a blower 23. The airflow channel 21 is provided with a flow rate adjusting damper 24 between the air intake port 22 and the blower 23. The airflow channel 21 is provided with a flow rate adjusting damper 25 between the blower 23 and the wind box 11. By driving the blower 23 with the flow rate adjusting damper 24 and the flow rate adjusting damper 25 open, air can be continuously supplied from the air intake port 22 to the wind box 11.

In the combustion chamber 12, the fluidizing medium 15 is arranged on the air dispersion plate 13. The fluidizing medium 15 may contain inert particles such as silica sand. When air is supplied from the wind box 11 to the combustion chamber 12 through the first air supply holes 14 of the air dispersion plate 13, the fluidizing medium 15 enters a fluidized state to form a fluidized bed. An air ratio in the fluidized bed may be about 0.5 to 1.5.

The combustion chamber 12 is provided with a second air supply port 16, a first biomass supply port 17, a second biomass supply port 18a, and a discharge port 19.

The second air supply port 16 is a supply port for supplying air to the combustion chamber 12. The second air supply port 16 is provided on a side wall constituting the combustion chamber 12. The second air supply port 16 is provided above the first air supply holes 14 in the vertical direction, and below the second biomass supply port 18a and the discharge port 19 in the vertical direction. The air supplied through the second air supply port 16 is secondary air. By supplying the secondary air to the combustion chamber 12, a stepwise combustion is possible at a temperature higher than the temperature by combustion with the primary air so that the fluidizing medium 15 can be prevented from being fixed by heat. The oxygen concentration in the carbonization region, which is described later, can also be adjusted by the secondary air.

The airflow channel 21 is connected to the second air supply port 16. The airflow channel 21 is branched between the blower 23 and the flow rate adjusting damper 25. The airflow channel 21 that is branched is provided with a flow rate adjusting damper 26 and a flow rate adjusting damper 27. By driving the blower 23 with the flow rate adjusting damper 24, the flow rate adjusting damper 26, and the flow rate adjusting damper 27 open, air can be continuously supplied from the air intake port 22 to the combustion chamber 12 through the second air supply port 16.

The first biomass supply port 17 is a supply port for supplying the first biomass to the combustion chamber 12. The first biomass can be supplied to the combustion chamber 12 through the first biomass supply port 17, so that the first biomass can be continuously supplied to the combustion chamber 12. Biomass is positioned as renewable energy, and from a concept of carbon neutrality, it is considered that burning biomass does not lead to an increase in carbon dioxide emitted into the atmosphere. By burning first biomass, use of fossil fuel can be reduced, and emission of carbon dioxide into the atmosphere can be prevented.

The first biomass supply port 17 is provided on a side wall constituting the combustion chamber 12. The first biomass supply port 17 is provided above the first air supply holes 14 in the vertical direction. The first biomass supply port 17 is connected to a first biomass supply section 30 for supplying the first biomass to the combustion chamber 12 of the combustion furnace 10. The first biomass supplied to the combustion chamber 12 by the first biomass supply section 30 is stirred together with the fluidizing medium 15, and burned.

The second biomass supply port 18a is a supply port for supplying the second biomass into the combustion chamber 12. When the second biomass is supplied into the combustion chamber 12, carbides are produced in the combustion chamber 12. The second biomass can be supplied to the combustion chamber 12 through the second biomass supply port 18a, so that the second biomass can be continuously supplied to the combustion chamber 12. The second biomass supply port 18a is provided on a side wall of the combustion chamber 12. The second biomass supply port 18a is provided downstream of the first biomass supply port 17. Specifically, the second biomass supply port 18a is provided above the first biomass supply port 17 in the vertical direction. The second biomass supply port 18a is provided downstream of the first air supply holes 14. The second biomass supply port 18a is connected to a second biomass supply section 31 for supplying the second biomass to the combustion chamber 12. The second biomass supplied to the combustion chamber 12 by the second biomass supply section 31 is carbonized, as described later, and carbides are produced from the second biomass.

The second biomass is supplied through the second biomass supply port 18a to a carbonization region in which a low-concentration oxygen gas produced by heating due to the combustion of the first biomass and having an oxygen concentration lower than that air due to the combustion of the first biomass exists. The carbonization region is maintained at a temperature suitable for the formation of carbides and a low oxygen concentration, and the second biomass is supplied in such a controlled atmosphere. The second biomass is heated by the high-temperature gas produced by the combustion of the first biomass. Therefore, the thermal decomposition of the second biomass proceeds stably, and carbides can be stably produced from the second biomass.

Properties of produced carbides vary depending on conditions such as a type and dry state of the second biomass, a supply amount of the second biomass, temperature of the carbonization region, and the oxygen concentration of the carbonization region. Therefore, the conditions of the supply amount of the second biomass, the temperature of the carbonization region, and the oxygen concentration of the carbonization region may be determined in advance in a trial run according to the properties of carbides to be produced.

The discharge port 19 is a discharge port for discharging a gas after the combustion of the first biomass. When carbides are produced from the second biomass in the combustion chamber 12, the carbides are also discharged through the discharge port 19. The carbides can be discharged from the discharge port 19 with a combustion gas whose volume is expanded by combustion. The discharge port 19 is provided above the first air supply holes 14, the second air supply port 16, the first biomass supply port 17, and the second biomass supply port 18a in the vertical direction. Specifically, the discharge port 19 is provided at a ceiling of the combustion chamber 12. The discharge port 19 is connected to a first connecting channel 36.

The first biomass and the second biomass may be the same type of biomass, or may be different types of biomass. The biomass may include, for example, wood, herbs, livestock manure, domestic wastewater such as sewage sludge and septic tank sludge, and organic matter such as food waste. The biomass may include at least one of waste biomass and unused biomass. The waste biomass may include livestock excreta such as chicken manure. The unused biomass may include at least one of non-edible parts of crops, forest residues, bamboo, and bamboo leafs. The non-edible parts of crops may include at least one selected from the group consisting of rice hull, rice straw, wheat straw, corn stalk, palm empty fruit bunch (EFB), old palm tree (OPT), and palm kernel hull (PKS). The biomass may include at least one of herb biomass and wood biomass. The wood biomass may include at least one of thinned wood and pruned branches. Among them, the biomass preferably includes at least one selected from the group consisting of rice husk, rice straw, wheat straw, chicken manure, corn stalk, bamboo, bamboo grass, thinned wood and pruned branches in terms of abundance and weight.

The first biomass supply section 30 and the second biomass supply section 31 may include continuous feeding feeders such as a screw feeder and a table feeder. The first biomass supply section 30 and the second biomass supply section 31 may also include a gravimetric feeder such as a loss-in-weight feeder, or a volumetric feeder. The amount of the second biomass supplied from the second biomass supply section 31 may be larger than the amount of the first biomass supplied from the first biomass supply section 30. The amount of the second biomass supplied from the second biomass supply section 31 may be, for example, 2 to 10 times the amount of the first biomass supplied from the first biomass supply section 30.

The carbide production system 1 may include a first crusher 32 and a second crusher 33. The first crusher 32 crushes the first biomass and the second biomass. The second crusher 33 further crushes the second biomass crushed by the first crusher 32. By crushing the first biomass by the first crusher 32, the first biomass can be crushed to a size suitable for combustion. By crushing the second biomass by the first crusher 32 and the second crusher 33 to reduce a particle size, the second biomass can be easily carbonized and transferred to the carbide recovery device 40. The second biomass supplied through the second biomass supply port 18a may be smaller in size than the first biomass supplied through the first biomass supply port 17. When the first biomass and the second biomass have optimal sizes, the first biomass and the second biomass may not be crushed by the first crusher 32 and the second crusher 33.

The carbide production system 1 may include at least one selected from a group consisting of a magnetic force sorter, a wind force sorter, and a particle size sorter (not illustrated). These sorters can remove foreign matter such as metal or concrete pieces from the first biomass supplied through the first biomass supply section 30 and the second biomass supplied through the second biomass supply section 31.

The combustion furnace 10 may include a thermometer 34 for measuring the temperature in the combustion chamber 12 above the second air supply port 16 in the vertical direction and below the discharge port 19 in the vertical direction. By measuring the temperature of the carbonization region by the thermometer 34, the carbonization temperature can be easily controlled. The temperature of the carbonization region may be about 700° C. to 1200° C. By setting the temperature of the carbonization region to 700° C. or higher, the carbonization can easily proceed even when the second biomass contains a lot of moisture. By setting the temperature of the carbonization region to 1200° C. or lower, the components of the second biomass or the like can be prevented from partially melting and adhering to an inner wall of the combustion furnace 10.

The combustion furnace 10 may include an oxygen meter 35 for measuring the oxygen concentration in the combustion chamber 12 above the second air supply port 16 in the vertical direction and below the discharge port 19 in the vertical direction. By measuring the oxygen concentration in the carbonization region by the oxygen meter 35, the oxygen concentration can be easily controlled. The oxygen concentration in the carbonization region may be about 0% to 7% by volume. By setting the oxygen concentration to 0% by volume or more, carbides can be easily produced even when a volatile content of the second biomass is large. Moreover, by setting the oxygen concentration to 7% by volume or less, production of carbon dioxide is promoted by combustion, and reduction of a residual amount of carbon can be prevented.

The combustion furnace 10 and the carbide recovery device 40 are connected through the first connecting channel 36. The first connecting channel 36 is provided with a second biomass supply port 18b for supplying the second biomass into the first connecting channel 36. When the second biomass is supplied into the first connecting channel 36, carbides are produced in the first connecting channel 36. Specifically, the second biomass is supplied through the second biomass supply port 18b to a carbonization region in which a low-concentration oxygen gas produced by heating due to the combustion of the first biomass and having an oxygen concentration lower than air due to the combustion of the first biomass exists. The gas in the combustion furnace 10 passes through the first connecting channel 36, so that there is a high-temperature and low-oxygen atmosphere. By supplying the second biomass into this atmosphere, as in the case in which the second biomass is supplied into the combustion chamber 12 through the second biomass supply port 18a, carbides can be stably produced from the second biomass.

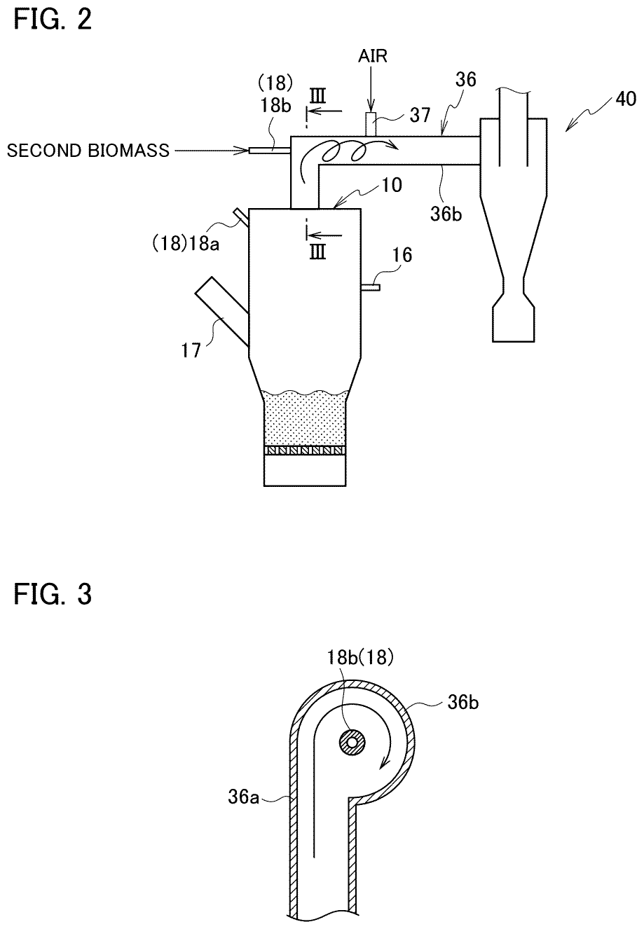

In this embodiment, as illustrated in FIGS. 2 and 3, the second biomass supply port 18b is provided at a substantially central portion of the cylindrical part of the first connecting channel 36 as viewed in the central axial direction. The first connecting channel 36 includes a first cylindrical tube 36a connected to the combustion furnace 10 and extending in the vertical direction, and a second cylindrical tube 36b connected to the carbide recovery device 40 and extending in the horizontal direction. As illustrated in FIG. 3, the first cylindrical tube 36a and the second cylindrical tube 36b are connected so that the central axis of the first cylindrical tube 36a is at a position different from the central axis of the second cylindrical tube 36b in the horizontal direction as viewed from the direction of the central axis of the second cylindrical tube 36b. Therefore, as indicated by arrows in FIGS. 2 and 3, the first connecting channel 36 is configured so that a gas fed from the combustion furnace 10 flows spirally through the second cylindrical tube 36b. As viewed from the direction of the central axis of the second cylindrical tube 36b, the second biomass supply port 18b is connected to the first connecting channel 36 so as to substantially coincide with the central axis of the second cylindrical tube 36b. Therefore, the second biomass is supplied to the central portion of the spirally flowing gas and flows spirally. Thus, a residence distance of the second biomass can be increased.

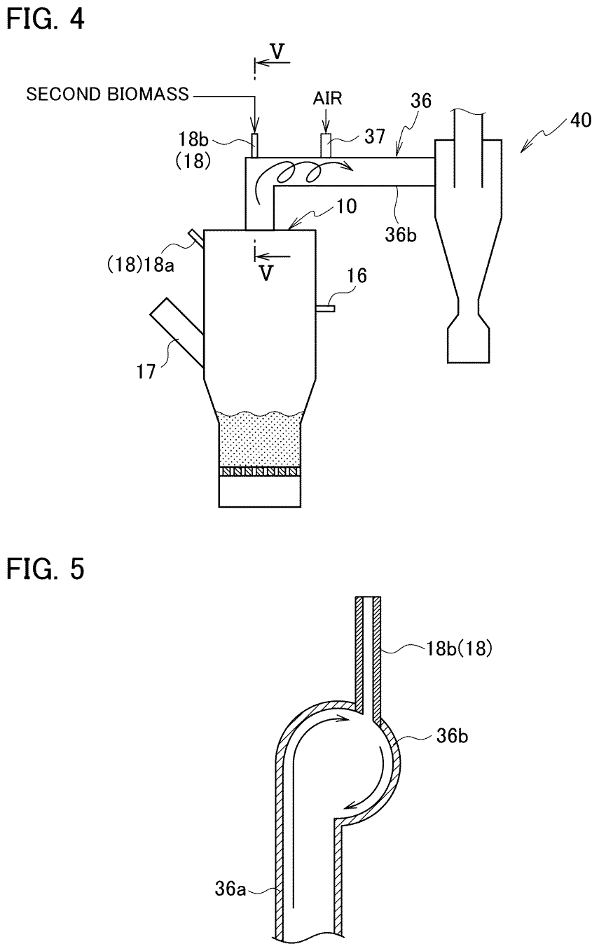

However, the position in which the second biomass supply port 18b is provided in the first connecting channel 36 is not limited to this configuration. For example, as illustrated in FIGS. 4 and 5, the second biomass supply port 18b may be provided on a side wall of the second cylindrical tube 36b. When the second biomass supply port 18b is provided on the side wall of the second cylindrical tube 36b, the supplied second biomass falls into the second cylindrical tube 36b. That is, the second biomass is easily entrained in the internal spiral flow, and the biomass having a relatively large particle size does not easily fall into the fluidized bed of the combustion furnace 10, so that stable combustion conditions can be maintained in the combustion furnace 10. Further, the particle size of the supplied biomass can be increased, so that the degree of freedom of carbide production can be widened.

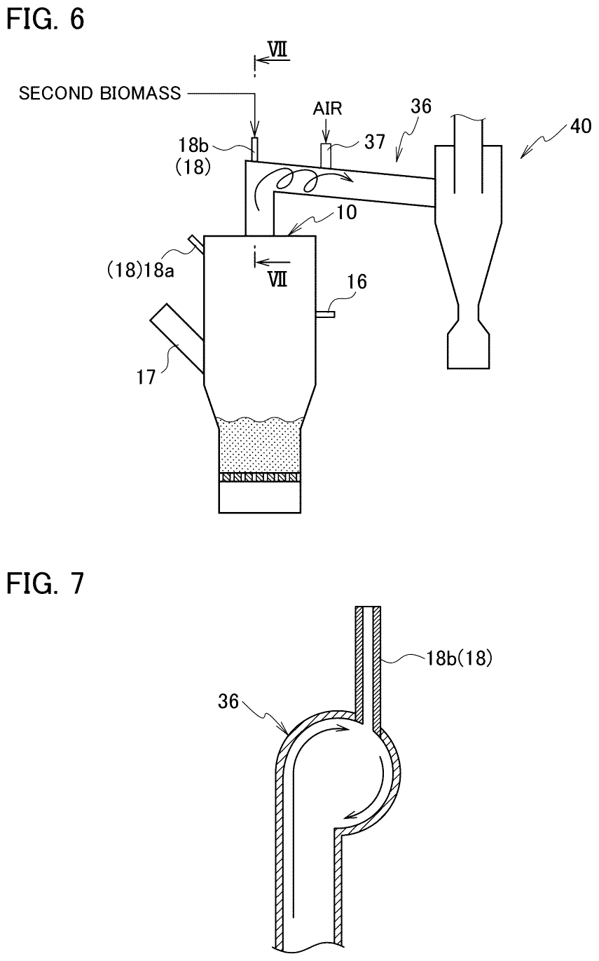

Further, the first cylindrical tube 36a extends in the vertical direction, and the second cylindrical tube 36b extends in the horizontal direction, but without limitation to this embodiment. For example, as illustrated in FIGS. 6 and 7, the second cylindrical tube 36b may be provided so as to incline downward in the vertical direction from the connecting portion with the first cylindrical tube 36a toward the carbide recovery device 40. Further, the first cylindrical tube 36a and the second cylindrical tube 36b are cylindrical in the present embodiment, but they may have an elliptical cylindrical shape, for example. Further, in the present embodiment, the first cylindrical tube 36a and the second cylindrical tube 36b are connected in an angular L-shape, but the first connecting channel 36 may have a curved portion and the first cylindrical tube 36a and the second cylindrical tube 36b may be connected via the curved portion.

Further, in the present embodiment, the second biomass supply port 18 includes the second biomass supply port 18a provided in the combustion chamber 12, and the second biomass supply port 18b provided in the first connecting channel 36. However, the second biomass supply port 18 may include one of the second biomass supply port 18a or the second biomass supply port 18b. That is, the second biomass supply port 18 only needs to include at least one of the second biomass supply port 18a or the second biomass supply port 18b.

As illustrated in FIG. 1, the first connecting channel 36 may be provided with a third air supply port 37 for supplying air into the first connecting channel 36. The temperature in the first connecting channel 36 may be lowered due to energy consumption caused by thermal decomposing of the second biomass. Further, when the second biomass contains a large amount of moisture, heat energy is used to vaporize the moisture, and the temperature in the first connecting channel 36 may decrease. Therefore, by supplying air from the third air supply port 37 into the first connecting channel 36, and burning a part of the second biomass in the first connecting channel 36, temperature decrease in the first connecting channel 36 can be prevented. Thus, the temperature in the first connecting channel 36 can be maintained at a temperature suitable for carbonization.

The third air supply port 37 may be provided closer to the second biomass supply port 18b than to the carbide recovery device 40 in the first connecting channel 36. Thus, unevenness of temperature in the first connecting channel 36 from the second biomass supply port 18b to the carbide recovery device 40 can be prevented.

The airflow channel 21 is connected to the third air supply port 37. The airflow channel 21 is branched between the blower 23 and the flow rate adjusting damper 25. The airflow channel 21 that is branched is provided with the flow rate adjusting damper 26 and a flow rate adjusting damper 28. By driving the blower 23 with the flow rate adjusting damper 24, the flow rate adjusting damper 26, and flow rate adjusting damper 28 open, air can be continuously supplied from the air intake port 22 through the third air supply port 37 into the first connecting channel 36.

The carbide recovery device 40 is connected to the combustion furnace 10, and recovers carbides generated from the second biomass. The carbide recovery device 40 may be a powder recovery device such as a bag filter, but the carbide recovery device 40 includes a cyclone in this embodiment. The cyclone is a device for separating and collecting carbides by centrifugal force. The carbide recovery device 40 is also supplied with gaseous tar derived from the thermal decomposition of the biomass in the combustion furnace 10. The cyclone can separate the gas and carbides without a filter in a high temperature state in which the tar does not condense, so that carbides with little tar adhesion can be easily recovered.

The cyclone includes a supply port 41 to which a carbide-dispersed gas is supplied, a main body 42 for centrifuging carbides, a dust collection chamber 43 for collecting carbides, and a discharge pipe 44 in a cylindrical shape for discharging a gas from which carbides are removed. The main body 42 has a cylindrical section 42a arranged at an upper part thereof, and a conical section 42b arranged below the cylindrical section 42a in the vertical direction. The discharge pipe 44 is arranged inside the cylindrical section 42a. The carbide falls in the main body 42, and is then collected in the dust collection chamber 43. The gas from which carbides are removed is discharged from the carbide recovery device 40 through the discharge pipe 44.

The dust collection chamber 43 is connected with a double damper 45 having two dampers in series. Each damper includes a lid 46. By opening one lid 46 and closing the other lid 46, the carbide can be taken out of the carbide recovery device 40 so as not to allow air in the atmosphere to enter. In place of the double damper 45, a rotary take-out device such as a rotary valve may be used. Further, a water sealing device connected to the main body 42 may be used as a take-out device. The water sealing device may include a water storage tank for storing water. One end of the main body 42 is sealed with water in the water storage tank, so that the carbides separated in the main body 42 is cooled by contacting with water in the water storage tank. The take-out device may be applied to the carbide recovery device 40 other than a cyclone.

Recovered carbides have carbon derived from the second biomass. By carbonizing the second biomass without burning it, emission of carbon dioxide into the atmosphere can be prevented. Obtained carbides may be used, for example, as a backfill material in a quarry site. In such a case, the same effect as CCS (carbon capture and storage) can be obtained. Carbon sequestration of carbides into soil is also possible. When carbides are used in an agricultural land such as paddies and fields, they also serve as a soil conditioner in addition to carbon sequestration. The carbide production system 1 according to the present embodiment can stably control the temperature and oxygen concentration in the carbonization region, so that the amount of carbon as well as the amount of components such as nitrogen, phosphorus, and potassium, which are essential nutrients for plants, in carbides can be optionally adjusted. Carbides are easy to heat by absorbing light, so that they can also be used as snow melting agents. The carbides can also be used as deodorants.

The carbide production system 1 may further include a gas utilization device 50 for utilizing a gas exhausted from the carbide recovery device 40. In this embodiment, the gas utilization device 50 includes a boiler. More specifically, the gas utilization device 50 includes an exhaust heat recovery boiler 51. The exhaust heat recovery boiler 51 recovers the heat of the gas exhausted from the carbide recovery device 40 by heat exchange to produce at least one of steam or hot water. The heat recovered by the exhaust heat recovery boiler 51 can be used as thermal energy in a factory or the like.

The gas utilization device 50 is connected to the carbide recovery device 40 through a second connecting channel 52. The second connecting channel 52 is provided with a fourth air supply port 53. The fourth air supply port 53 is connected to the airflow channel 21. The airflow channel 21 is branched between the blower 23 and the flow rate adjusting damper 25. The airflow channel 21 that is branched is provided with the flow rate adjusting damper 26 and a flow rate adjusting damper 29. By driving the blower 23 with the flow rate adjusting damper 24, the flow rate adjusting damper 26, and the flow rate adjusting damper 29 open, air can be continuously supplied from the air intake port 22 to the second connecting channel 52 through the fourth air supply port 53. By supplying air into the second connecting channel 52, residual combustible components can be burned.

The carbide production system 1 may include a thermometer 54 provided downstream of the fourth air supply port 53 and measuring the temperature inside the second connecting channel 52. Thus, the temperature of the gas supplied to the gas utilization device 50 can be controlled. Further, the carbide production system 1 may be provided with an oxygen meter 55 which is provided downstream of the fourth air supply port 53, and measures the oxygen concentration inside the second connecting channel 52. Thus, the oxygen concentration of the gas supplied to the gas utilization device 50 can be controlled.

An ash separation device 56 is connected to the exhaust heat recovery boiler 51. The ash separation device 56 removes ash from a gas discharged from the exhaust heat recovery boiler 51. A cyclone 57 is connected to the ash separation device 56. The gas from which the ash is separated by the ash separation device 56 is supplied to the cyclone 57. A small amount of fine particles may remain in the gas supplied to the cyclone 57. The fine particles can be released into the atmosphere after being separated by the cyclone 57.

A gas exhaust port of the cyclone 57 is connected to the dust collection chamber 43 of the carbide recovery device 40 through a cooling gas flow channel 58. The cooling gas flow channel 58 is provided with a flow rate adjusting damper 59 and a circulating cooling fan 60. By driving the circulating cooling fan 60 with the flow rate adjusting damper 59 open, a gas is supplied from the cyclone 57 to the carbide recovery device 40. Therefore, in the carbide recovery device 40, carbides are cooled by a gas derived from a gas exhausted from the carbide recovery device 40, and cooled by heat exchange in the gas utilization device 50. The carbides just recovered in the carbide recovery device 40 are at a high temperature, and may be burned by oxygen in the air when they come into contact with air. However, the oxygen concentration of the gas exhausted from the carbide recovery device 40 is low. The heat of the gas exhausted from the carbide recovery device 40 is recovered and cooled by the gas utilization device 50. Therefore, by using the gas for cooling recovered carbides, the carbides can be cooled without separately preparing a cooling gas having a low oxygen concentration.

It is also possible to introduce a gas having a low oxygen concentration into the carbide recovery device 40 at a low temperature of 200° C. or less by a cooling device (not illustrated) without using the gas utilization device 50 as in this embodiment. Even with this configuration, combustion of carbides recovered by the carbide recovery device 40 can be prevented. In the case of using the water sealing device as described above, carbides can be cooled by water, and thereby the carbides can be cooled without using low-temperature gas having a low oxygen concentration.

As described above, the carbide production system 1 according to the present embodiment includes the combustion furnace 10 having the first biomass supply port 17 for supplying the first biomass and including the combustion chamber 12 for burning the first biomass with air. The carbide production system 1 includes a carbide recovery device 40 connected to the combustion furnace 10 for recovering carbides produced from the second biomass. The second biomass is supplied through the second biomass supply port 18 to a carbonization region in which a low-concentration oxygen gas produced by heating due to the combustion of the first biomass and having an oxygen concentration lower than air due to the combustion of the first biomass exists. The second biomass supply port 18 is provided downstream of the first biomass supply port 17.

The carbide production method according to the present embodiment also includes a step of burning the first biomass supplied to the combustion chamber 12 of the combustion furnace 10 with air. The carbide production method includes a step of supplying the second biomass to a carbonization region downstream of the first biomass in which a low-concentration oxygen gas produced by heating due to the combustion of the first biomass and having an oxygen concentration lower than air due to the combustion of the first biomass exists. The carbide production method includes a step of recovering carbides produced from the second biomass by the carbide recovery device 40 connected to the combustion furnace 10.

Therefore, according to the carbide production system 1 according to the present embodiment, stable carbides can be continuously produced from biomass. For example, a moisture concentration of a biomass raw material such as rice husk varies and its properties change depending on a storage condition, but with the carbide production system 1 according to the present embodiment, a stable high-temperature atmosphere can be controlled and maintained.

### Second Embodiment

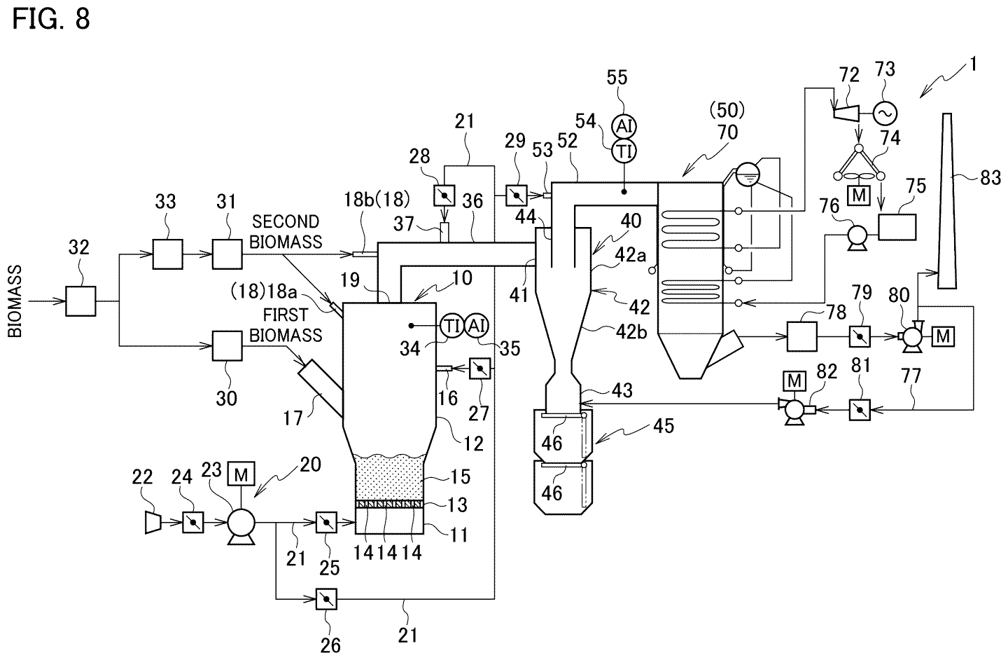

Next, the carbide production system 1 according to the second embodiment will be described with reference to FIG. 8. The carbide production system 1 according to the second embodiment differs from the carbide production system 1 according to the first embodiment in the configuration of the gas utilization device 50. Since the carbide production system 1 according to the second embodiment is similar to the first embodiment in other aspects, the description thereof will be omitted.

As illustrated in FIG. 8, the gas utilization device 50 according to the present embodiment includes a heat recovery steam generator 70. The carbide production system 1 includes a turbine 72, a generator 73, an air-cooled steam condenser 74, and a condenser tank 75.

The heat recovery steam generator 70 is connected to the second connecting channel 52. The heat recovery steam generator 70 recovers the heat of the gas exhausted from the carbide recovery device 40 by heat exchange to produce steam. The steam that has expanded in volume as steam passes through the turbine 72, and is used as power to rotate the turbine 72. The turbine 72 is mechanically connected to the generator 73, and the generator 73 generates electric power by rotation of the turbine 72. The steam exhausted from the turbine 72 is supplied to the air-cooled steam condenser 74. The steam supplied to the air-cooled steam condenser 74 is cooled and condensed, and the condensed water is stored in the condenser tank 75. The water in the condenser tank 75 is supplied to the heat recovery steam generator 70 by driving of the pump 76, and circulates.

A gas exhaust port of the heat recovery steam generator 70 is connected to the dust collection chamber 43 of the carbide recovery device 40 through a cooling gas flow channel 77. The cooling gas flow channel 77 is provided with a bag filter 78, a flow rate adjusting damper 79, an induction fan 80, a flow rate adjusting damper 81, and a circulating cooling fan 82 in this order from the gas exhaust port of the heat recovery steam generator 70 toward the dust collection chamber 43 of the carbide recovery device 40. Fine particles in the gas exhausted from the heat recovery steam generator 70 are collected by the bag filter 78. By driving the induction fan 80 with the flow rate adjusting damper 79 open, a part of the gas from which the fine particles have been removed is discharged from a chimney 83 into the atmosphere. By driving the circulating cooling fan 82 with the flow rate adjusting damper 81 open, a part of the gas from which the fine particles have been removed is supplied to the dust collection chamber 43 of the carbide recovery device 40. Therefore, in the carbide recovery device 40, carbides are cooled by the gas derived from the gas exhausted from the carbide recovery device 40 and cooled by heat exchange in the gas utilization device 50.

According to the carbide production system 1 according to the present embodiment, stable carbides can be continuously produced from biomass, and power can be generated.

### Third Embodiment

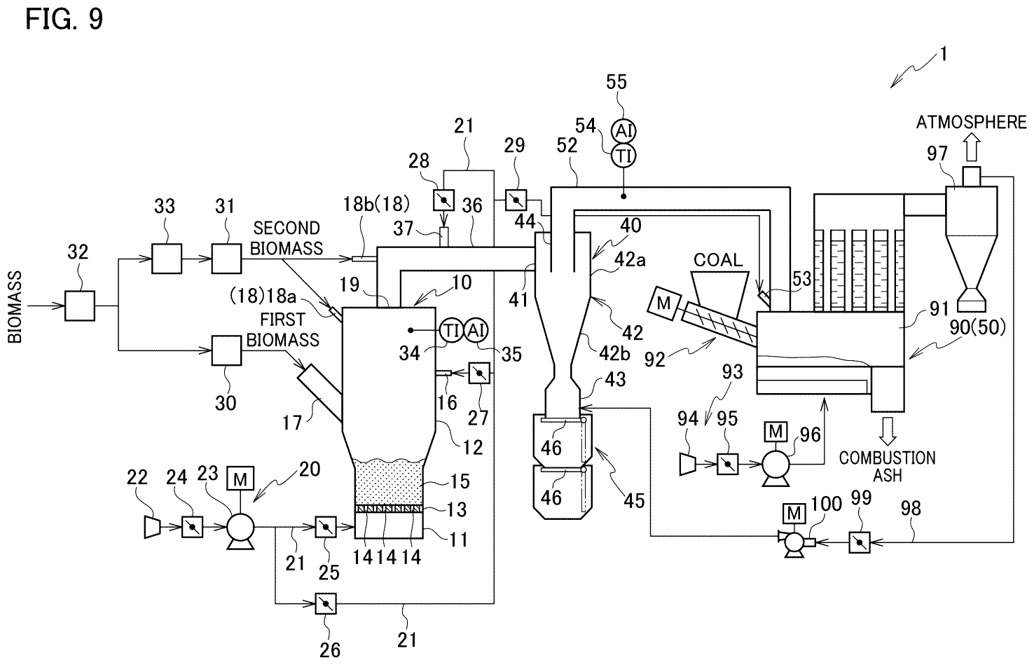

Next, a carbide production system 1 according to a third embodiment will be described with reference to FIG. 9. The carbide production system 1 according to the third embodiment differs from the carbide production system 1 according to the first embodiment in the form of a gas utilization device 50. The carbide production system 1 according to the third embodiment is similar to the first embodiment in other aspects, and the description thereof will be omitted.

As illustrated in FIG. 9, the gas utilization device 50 according to the present embodiment includes a coal-fired boiler 90. The carbide production system 1 according to the present embodiment includes a cyclone 97.

The coal-fired boiler 90 is a boiler using coal as fuel. Coal is supplied to a combustion chamber 91 of the coal-fired boiler 90 by a coal supply unit 92, and air is supplied by an air supply section 93. Specifically, the air supply section 93 includes an air intake port 94, a flow rate adjusting damper 95, and a blower 96. By driving the blower 96 with the flow rate adjusting damper 95 open, air is supplied from the air intake port 94 to the combustion chamber 91.

The coal-fired boiler 90 is connected to the second connecting channel 52. In this embodiment, unlike the first embodiment, the fourth air supply port 53 is provided in the second connecting channel 52 at a position closer to the coal-fired boiler 90 than to the carbide recovery device 40. Therefore, combustible components discharged from the carbide recovery device 40 can be burned in the coal-fired boiler 90. This combustion heat can be recovered by heat exchange in the coal-fired boiler 90, so that the coal used in the coal-fired boiler 90 can be reduced. Note that a heavy oil-fired boiler or a gas-fired boiler may be used instead of the coal-fired boiler 90. Even in these cases, the fossil fuel can be reduced.

A gas exhaust port of the coal-fired boiler 90 is connected to the cyclone 97. The gas in the combustion chamber 91 is cooled by heat exchange, and the cooled gas passes through the cyclone 97. In the cyclone 97, fine particles are collected, and a part of the gas is discharged into the atmosphere from the cyclone 97.

The cyclone 97 and the dust collection chamber 43 of the carbide recovery device 40 are connected through a cooling gas flow channel 98. The cooling gas flow channel 98 is provided with a flow rate adjusting damper 99 and a circulating cooling fan 100. By driving the circulating cooling fan 100 with the flow rate adjusting damper 99 open, a part of the gas from which fine particles are removed is supplied to the dust collection chamber 43 of the carbide recovery device 40. Therefore, in the carbide recovery device 40, carbides are cooled by a gas derived from a gas discharged from the carbide recovery device 40 and cooled by heat exchange in the gas utilization device 50.

With the carbide production system 1 according to the present embodiment, stable carbides can be continuously produced from biomass, and the use of coal required for the coal-fired boiler 90 can be reduced.

In the first to third embodiments, only the blower 23 is used to supply air to the carbide production system 1 through a plurality of air supply ports. However, a blower may be arranged upstream of each flow rate adjusting damper to supply air to the carbide production system 1 through each air supply port.

The entire contents of Japanese Patent Application No. 2022-102517, filed Jun. 27, 2022, are incorporated herein by reference.

Although several embodiments have been described, modifications or variations of the embodiments may be made based on the above disclosure. All the components of the above embodiments and all the claimed features may be individually extracted and combined as long as they are not inconsistent with each other.

This disclosure may contribute, for example, to Goal 2 “End hunger, achieve food security and improved nutrition, and promote sustainable agriculture,” Goal 13 “Take urgent action to combat climate change and its impacts,” and Goal 15 “Protect, restore and promote sustainable use of terrestrial ecosystems, sustainably manage forests, combat desertification, and halt and reverse land degradation and halt biodiversity loss” in the Sustainable Development Goals (SDGs) led by the United Nations.

What is claimed is:

1. A carbide production system, comprising:
a combustion furnace having a first biomass supply port for supplying first biomass and including a combustion chamber for burning the first biomass with air; and
a carbide recovery device connected to the combustion furnace for recovering carbides produced from second biomass;
wherein the second biomass is supplied through a second biomass supply port provided downstream of the first biomass supply port to a carbonization region in which a low-concentration oxygen gas produced by heating due to combustion of the first biomass and having an oxygen concentration lower than air due to the combustion of the first biomass exists.

2. The carbide production system according to claim 1, wherein the combustion furnace is a vertical combustion furnace.

3. The carbide production system according to claim 1, wherein
the combustion chamber is provided with the second biomass supply port for supplying the second biomass into the combustion chamber; and
the carbides are produced in the combustion chamber.

4. The carbide production system according to claim 1, wherein
the combustion furnace and the carbide recovery device are connected through a connecting channel;
the connecting channel is provided with the second biomass supply port for supplying the second biomass into the connecting channel; and
the carbides are produced in the connecting channel.

5. The carbide production system according to claim 1, wherein
the combustion furnace and the carbide recovery device are connected through a connecting channel; and
the connecting channel is provided with an air supply port for supplying air into the connecting channel.

6. The carbide production system according to claim 1, wherein the carbide recovery device comprises a cyclone.

7. The carbide production system according to claim 1, further comprising a gas utilization device for utilizing a gas exhausted from the carbide recovery device; and
the carbides are cooled in the carbide recovery device by a gas derived from a gas exhausted from the carbide recovery device and cooled by heat exchange in the gas utilization device.

8. A carbide production method comprising:
burning first biomass supplied to a combustion chamber of a combustion furnace with air,
supplying second biomass to a carbonization region downstream of the first biomass, in which a low-concentration oxygen gas produced by heating due to combustion of the first biomass and having an oxygen concentration lower than air due to combustion of the first biomass exists; and
recovering carbides produced from the second biomass in a carbide recovery device connected to the combustion furnace.
